(19) United States
(12) Patent Application Publication
(10) Pub. No.: US 2012/0304413 A1
(43) Pub. Date: Dec. 6, 2012

(54) WINDSCREEN WIPER DEVICE

(76) Inventor: Xavier Boland, Arlon (BE)

(21) Appl. No.: 13/579,351

(22) PCT Filed: Feb. 17, 2010
(86) PCT No.: PCT/EP2010/051982

§ 371 Date: Aug. 16, 2012

(51) Int. Cl. B60S 1/40

(52) U.S. Cl. 15/250.3

(57) ABSTRACT

A windscreen wiper device includes an elastic, elongated carrier element, as well as an elongated wiper blade of a flexible material, which can be placed in abutment with a windscreen to be wiped, which wiper blade includes a central longitudinal groove, in which groove a central longitudinal strip of the carrier element is disposed. Connecting pieces are provided at both ends of the wiper blade and a connecting device is provided for an oscillating wiper arm. The wiper blade includes an elongated upper holding part and an elongated lower wiping part of a flexible material. The holding part holds the wiping part, and includes downwardly extending side arms, seen in cross-section, for holding the wiping part, from the outside in a lateral region thereof The connecting pieces comprise engaging members that sidewardly engage the upper holding part, and the engaging members comprise legs extending laterally from the engaging members over the length thereof in the direction of the downwardly extending side arms. The wiper device comprises retaining means for retaining the connecting pieces onto the wiper blade.

### BACKGROUND OF THE INVENTION

1. Technical Field

The invention relates to a windscreen wiper device comprising an elastic, elongated carrier element, as well as an elongated wiper blade of a flexible material, which can be placed in abutment with a windscreen to be wiped, which wiper blade includes a central longitudinal groove, in which groove a central longitudinal strip of the carrier element is disposed, wherein connecting pieces are provided at both ends of the wiper blade, which windscreen wiper device comprises a connecting device for an oscillating wiper arm.

2. Related Art

Such a windscreen wiper device is generally known. This prior art windscreen wiper device is designed as a so-called “fiat blade” or “yokeless blade”, wherein no use is made of several yokes pivotally connected to each other, but wherein the wiper blade is biassed by the carrier element, as a result of which it exhibits a specific curvature. A disadvantage of this known wiper device is that dust and water can get into the central longitudinal groove, because of which the strip cannot move freely in the groove and because of which corrosion of the strip can occur.

### SUMMARY OF THE INVENTION

The object of the invention is to overcome this drawback of the prior art as indicated above, in particular to provide a windscreen wiper device wherein the connecting pieces (“end caps”) prevent dust and water from getting into the longitudinal groove.

In order to accomplish that objective, a windscreen wiper device of the kind referred to in the introduction according to the invention is characterized in that the wiper blade comprises an elongated upper holding part and an elongated lower wiping part of a flexible material, wherein the holding part holds the wiping part, wherein the holding part comprises downwardly extending side arms, seen in cross-section, for holding the wiping part, from the outside in a lateral region thereof, wherein the connecting pieces comprise engaging members that sidewardly engage the upper holding part, and wherein the engaging members comprise legs extending laterally from the engaging members over the length thereof in the direction of the downwardly extending side arms, wherein the wiper device comprises retaining means for retaining the connecting pieces onto the wiper blade. Because the connecting pieced are connected to the wiper blade without any connection between the connecting pieces and the strip, the connecting pieces close the groove in a dust tight and watertight manner. This implies that any decrease in mobility between the wiper blade and the strip due to any dust inside the groove is avoided, whereas any corrosion of the strip due to any (rain) water inside the groove is avoided as well.

In one preferred embodiment of a windscreen wiper device in accordance with the invention the retaining means comprise at least one protrusion extending from the legs in the direction of the downwardly extending side arms. the protrusions realize that the connecting pieces are blocked against any movement in longitudinal direction with respect to the wiper blade.

In another preferred embodiment of a windscreen wiper device in accordance with the invention the holding part is provided with an elongated reinforcement element, wherein the reinforcement element is provided with spaced-apart profiles extending in transverse and longitudinal directions, and wherein the protrusion extends in an opening formed by the spaced-apart profiles. In this embodiment, the protrusions realize that the connecting pieces are strongly blocked against any movement in longitudinal direction with respect to the wiper blade.

In another preferred embodiment of a windscreen wiper device in accordance with the invention the wiper blade and the groove are longer than the strip at both ends of the wiper blade thus forming a space, wherein the connecting piece comprise an interior protrusion fitting inside the space in order to dust and water tightly close the groove at both ends of the wiper blade. Particularly by slidingly mounting the connecting pieces over the respective free ends of the wiper blade, the interior protrusions are slided in the respective spaces of the wiper blade. Preferably, the interior protrusion extends longitudinally from an end wall of each connecting piece.

In another preferred embodiment of a windscreen wiper device in accordance with the invention the strip is provided with a lubricant. The lubricant reduces the friction of the strip in the groove. Because the groove is closed in a dust tight and watertight manner, the lubricant will stay in the groove, thereby maintaining the reduced friction. This particularly achieved when the space is closed by the interior protrusion. Preferably, the lubricant is a powder, more the lubricant is chosen from the group consisting of talc, sulfur and graphite.

In another preferred embodiment of a windscreen wiper device in accordance with the invention the holding part is provided with a spoiler at a side thereof facing away from the wiping part.

### THE DRAWINGS

The invention will now be explained in more detail with reference to figures illustrated in a drawing, wherein:

FIG. 1 is a perspective, schematic view of a preferred embodiment of a windscreen wiper device according to the invention;

FIG. 2 is a cross-section of the windscreen wiper device of FIG. 1;

FIG. 3 is a perspective view of a reinforcement element of the windscreen wiper device of FIG. 1;

FIG. 4 is a detailed view of a connecting piece according to the invention;

FIG. 5 is a detailed view of the connecting piece mounted on the windscreen wiper device according to the invention;

FIG. 6 is cross-section in the horizontal plane of the connecting piece mounted on the windscreen wiper device according to the invention; and

FIG. 7 is longitudinal cross-section in the vertical plane of the connecting piece mounted on the windscreen wiper device according to the invention.

### DETAILED DESCRIPTION

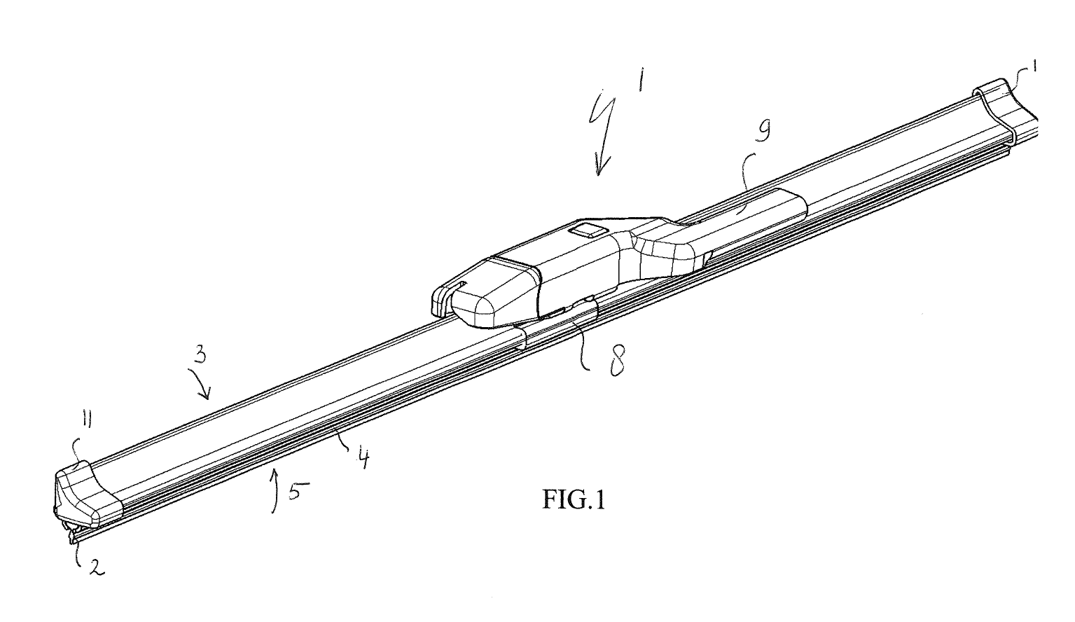

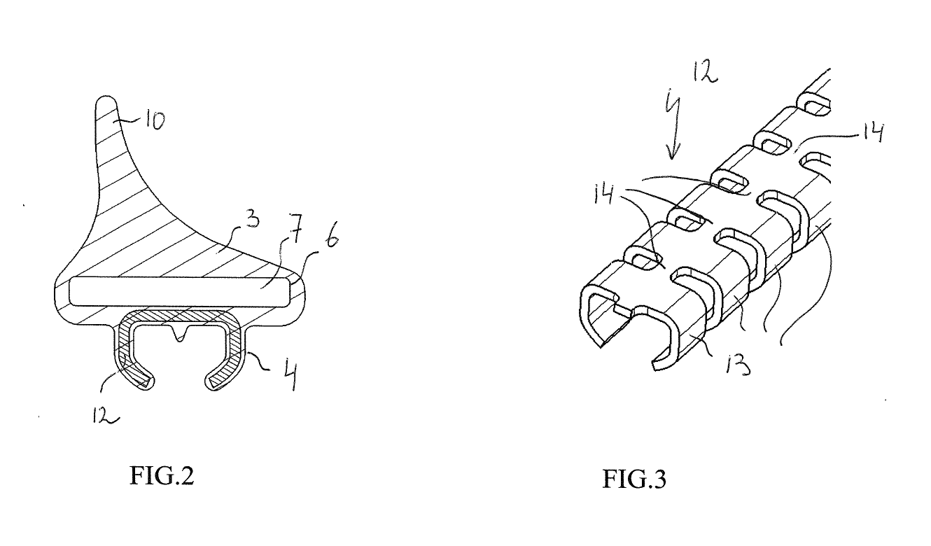

FIG. 1 shows a preferred variant of a windscreen wiper device I according to the invention. the windscreen wiper device 1 is built up of a wiper blade 2 comprising a rubber or plastic elongated upper holding part 3 with downwardly extending side arms 4 holding an elastomeric elongated lower wiping part 5, wherein upper holding part 3 and lower wiping part 5 extend in longitudinal direction along the entire length of the wiper blade 2. In the holding part 3 a central longitudinal groove 6 is formed, in which a longitudinal strip 7 made of spring band steel is fitted (FIG. 2). The strip 7 forms a flexible carrier element for the rubber wiper blade 2, as it were, which is thus biased in a curved position (the curvature in operative position being that of a windscreen to be wiped).

The windscreen wiper device 1 is further equipped with a connecting device 8 for an oscillating arm 9, and a spoiler 10. At both ends of the wiper blade 2, that is on either side of the windscreen wiper device 1, connecting pieces 11 are provided. Upper holding part 3 is further provided with a reinforcement element 12 of metal. The reinforcement element 12 extending in longitudinal direction along the entire length of the holding part 3 has a bending stiffness in transverse direction and is flexible in longitudinal direction. This is realized by providing the reinforcement element 12 with profiles 13 having a C-shaped cross-section (FIG. 2) spaced-apart by spacers 14 and extending in transverse and longitudinal directions. The reinforcement element 12 enhances the stiffness of the holding part 3 in transverse direction, allowing the holding part 3 to firmly retain the wiping part 5 thereon. Simultaneously, the reinforcement element 12 is flexible enough to follow any bending of the longitudinal strip 7 along the curvature of the windscreen to be wiped. Accordingly, the reinforcement element 12 incorporates two features which at first sight appear to be incompatible, namely having a bending stiffness in transverse direction and having flexibility in longitudinal direction. This is particularly achieved by the profiles 13 put at a distance from each other.

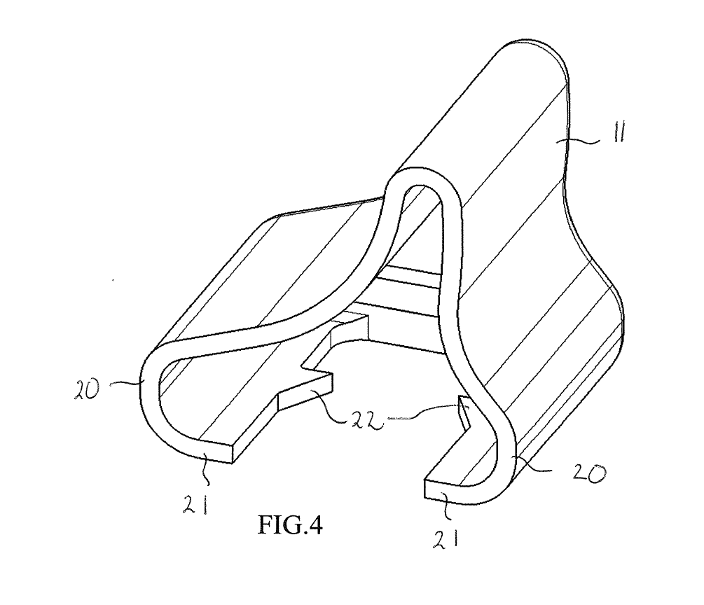

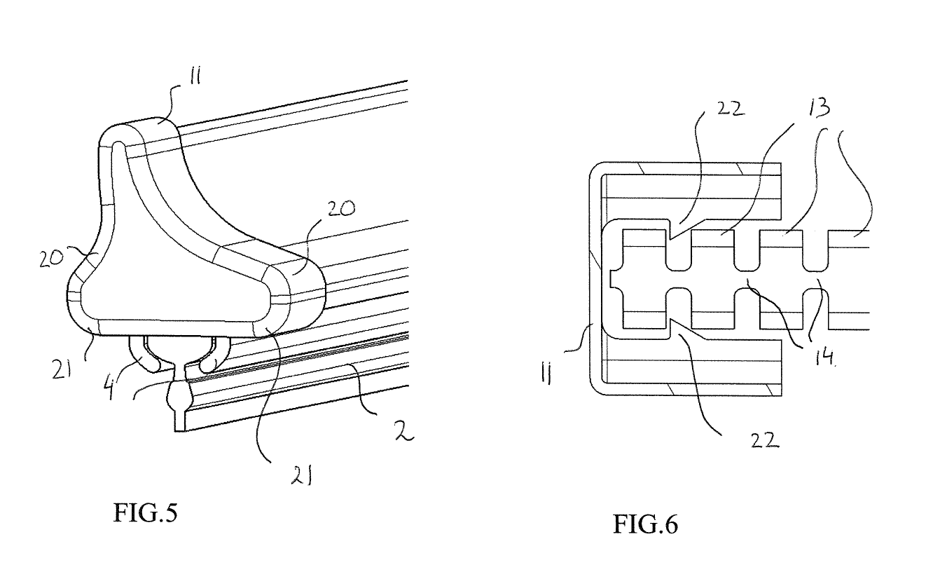

With reference to FIGS. 4 through 6, each connecting piece 11 is provided with two engaging members 20 made integral therewith, wherein the engaging members 10 engage around the upper holding part 3. The engaging members 20 comprise legs 21 made integral therewith extending laterally from the engaging members 20 over the length thereof in the direction of the downwardly extending side arms 4 of upper holding part 3. Connecting piece 11 can be slidingly mounted of over the ends of the wiper blade 2. Further, the legs 21 comprise protrusions 22 made integral therewith extending from the legs 21 in the direction of the downwardly extending side arms 4 of upper holding part 3, wherein the protrusions 22 in mounted position extend in the rubber of wiper blade 2 in the openings 23 formed by C-shaped profile 13 and spacer 14. Hence, the protrusions 22 realize that the connecting pieces 11 are blocked against any movement in longitudinal direction with respect to the wiper blade 2. It is noted that the protrusions 22 only slightly penetrates the elastomeric (rubber) or plastic material of the wiper blade 2, without damaging the same.

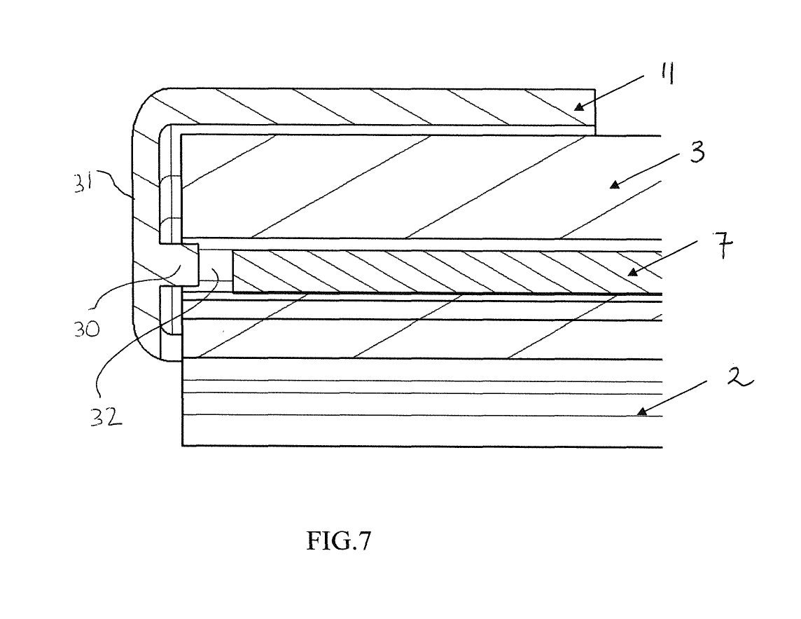

With reference to FIG. 7, the connecting pieces 11 are each provided with a finger or protrusion 30 extending in longitudinal and inward direction from the end wall 31 thereof. When a connecting piece 11 is slidably mounted over a free end of the wiper blade 2, the protrusion 30 slides inside a blind hole 32 of the wiper blade 2. The blind hole 32 is formed if the wiper blade 2 and the groove 6 are longer than the strip 7. Preferably, the strip 7 is provided with a lubricant, in particular a powder such as talc, in order to reduce friction of the strip 7 in the groove 6. In particular when the blind hole 31 is closed by the protrusion 30, the lubricant will stay in the groove 6, thereby maintaining reduced friction.

According to the invention the connecting pieces 11 or “end caps” are connected to the wiper blade 2 without any connection between the connecting pieces 11 and the strip 7.

Although not depicted in the figures, it will be clear for a person skilled in the art that the oscillating wiper arm 9 is connected to a mounting head fixed for rotation to a shaft driven by a small motor. In use, the shaft rotates alternately in a clockwise and in a counter-clockwise sense carrying the mounting head into rotation also, which in turn draws the oscillating wiper arm 9 into rotation and by means of the connecting device 8 moves the wiper blade 2.

The present invention is not limited to the embodiment shown, but extends also to other embodiments falling within the scope of the appended claims.

1. A windscreen wiper device comprising an elastic, elongated carrier element, as well as an elongated wiper blade of a flexible material, which can be placed in abutment with a windscreen to be wiped, which wiper blade includes a central longitudinal groove, in which groove a central longitudinal strip of the carrier element is disposed, wherein connecting pieces are provided at both ends of said wiper blade, which windscreen wiper device comprises a connecting device for an oscillating wiper arm, wherein said wiper blade comprises an elongated upper holding part and an elongated lower wiping part of a flexible material, wherein said holding part holds said wiping part, wherein said holding part comprises downwardly extending side arms, seen in cross-section, for holding said wiping part, from the outside in a lateral region thereof, wherein the connecting pieces comprise engaging members that sidewardly engage said upper holding part, and wherein said engaging members comprise legs extending laterally from said engaging members over the length thereof in the direction of said downwardly extending side arms, wherein said wiper device comprises retaining structure serving to retain said connecting pieces onto said wiper blade.

2. A windscreen wiper device according to claim 1, wherein said retaining structure comprise at least one protrusion extending from said legs in the direction of said downwardly extending side arms.

3. A windscreen wiper device according to claim 2, wherein said holding part is provided with an elongated reinforcement element, wherein said reinforcement element is provided with spaced-apart profiles extending in transverse and longitudinal directions, and wherein said protrusion extends in an opening formed by said spaced-apart profiles.

4. A windscreen wiper device according to claim 1, wherein said wiper blade and said groove are longer than said strip at both ends of said wiper blade thus forming a space, wherein said connecting pieces comprise an interior protrusion fitting inside said space in order to dust and water tightly close said groove at both ends of said wiper blade.

5. A windscreen wiper device according to claim 1, wherein said interior protrusion extends longitudinally from an end wall of each connecting piece.

6. A windscreen wiper device according to claim 1, wherein said strip is provided with a lubricant.

7. A windscreen wiper device according to claim 6, wherein said lubricant is a powder.

8. A windscreen wiper device according to claim 6, wherein said lubricant is chosen from the group consisting of talc, sulfur and graphite.

9. A windscreen wiper device according to claim 1, wherein said holding part is provided with a spoiler at a side thereof facing away from said wiping part.
